(19) United States
(12) Patent Application Publication
(10) Pub. No.: US 2013/0263401 A1
(43) Pub. Date: Oct. 10, 2013

(54) WIPER BLADE DEVICE

(71) Applicants: Koen Bex, Jeuk (BE); Dirk Herinckx, Linter (BE); Helmut Depondt, Kessel-Lo (BE)

(72) Inventors: Koen Bex, Jeuk (BE); Dirk Herinckx, Linter (BE); Helmut Depondt, Kessel-Lo (BE)

(73) Assignee: ROBERT BOSCH GMBH, Stuttgart (DE)

(21) Appl. No.: 13/993,840

(22) PCT Filed: Nov. 9, 2011
(86) PCT No.: PCT/EP11/69740

§ 371 Date: Jun. 13, 2013

(30) Foreign Application Priority Data
Dec. 13, 2010 (DE) 102010062906.5

(51) Int. Cl. B60S 1/38

(52) U.S. Cl. CPC B60S 1/38
USPC 15/250.48; 15/250.361

(57) ABSTRACT

The invention relates to a wiper blade device comprising a wiper strip unit (10) which has a longitudinal guide channel (14) for accommodating a support element (16). According to the invention, the longitudinal guide channel (14) has at least one lateral opening (12).

### BACKGROUND OF THE INVENTION

The invention relates to a wiper blade device.

A wiper blade device comprising a wiper strip unit which has a longitudinal guide channel for accommodating a support element is already known from prior art.

### SUMMARY OF THE INVENTION

The invention relates to a wiper blade device comprising a wiper strip unit which has a longitudinal guide channel for accommodating a support element.

According to the invention, the longitudinal guide channel has at least one lateral opening, whereby material can be advantageously saved during manufacture. By the term “wiper strip unit”, particularly a unit is to be understood in this context, which is provided for the purpose of connecting a wiper blade adapter to a wiper lip. By the term “longitudinal guide channel”, particularly a guide channel is to be understood in this context, which in the assembled state extends in a longitudinal extension of the wiper strip unit. By the term “longitudinal extension”, particularly an extension that is as large as possible is to be understood in this context. By the term “extension” of an element, particularly a maximum distance between two points of a vertical projection of the element onto a plane is to be understood. By the term “lateral opening”, particularly a recess is to be understood in this context, which is arranged in a lateral wall of the wiper strip unit and forms a passage into the longitudinal channel. The lateral opening is preferably delimited by a closed contour. In a particularly preferred manner, a main extension of the lateral opening extends parallel to the longitudinal extension of the wiper strip unit. By the term “support element”, particularly a resilient element is to be understood in this context, which has at least one extension that can be resiliently varied by at least 10%, particularly by at least 20%, preferably by at least 30% and particularly advantageously by at least 50% in a normal operating state and which generates a counter force acting against a variance of the extension, which is a function of the variance and is preferably proportional to said variance. By the term “provided”, in particular specially designed and/or equipped is to be understood. By the term “wiper blade adapter”, particularly an adapter is to be understood in this context, which is intended for the purpose of providing a coupling region of the wiper blade device for a coupling to a wiper arm.

If the at least one lateral opening adjoins intermediate elements of the wiper strip unit, the wiper blade device can be embodied in a particularly stable manner. By the term “intermediate element”, particularly an element is to be understood in this context, which is arranged between two components of the wiper strip unit and connects the same to one another.

The invention further proposes that the intermediate elements are integrally designed with a further component of the wiper strip unit, whereby a particularly stable connection is achieved which at the same time is cost effective. In this case, a further component can relate to a wiper lip; however, said component preferably relates to a wind deflector. By the term “wind deflector”, particularly an element is to be understood, which is provided for the purpose of deflecting an airstream acting on the wiper blade device and/or is used for pressing the wiper lip against a vehicle's window pane. The wind deflector preferably has at least one concave surface. By the term “integral(ly)”, in particular joined by material engagement, as for example by a welding process and/or an adhesive bonding process etc., and in a particularly advantageous manner “molded” are to be understood, molded thereby referring to manufacture by casting in one piece and/or in a single-component or multi-component injection molding process.

In a further embodiment of the invention, it is proposed that the intermediate elements are disposed in two longitudinal rows, whereby a particularly stable embodiment of the wiper blade device can be achieved. By the term “longitudinal row”, particularly a row of intermediate elements is to be understood in this context, which extends parallel to the longitudinal extension of the wiper strip unit.

If the intermediate elements of a longitudinal row are arranged offset as seen in a longitudinal direction to the intermediate elements of the other longitudinal row, forces acting on the wiper strip unit can be especially evenly distributed. By the term “longitudinal direction”, particularly a direction is to be understood in this context, which substantially extends parallel to a longitudinal extension of the wiper strip unit. By the term “substantially”, particularly a deviation of less than 10° and preferably less than 5° is to be understood. By the term “offset”, it should be particularly understood in this context that a plane which extends perpendicularly to the longitudinal direction and moves in said longitudinal direction simultaneously intersects only one intermediate element across the majority of the longitudinal extension thereof. In a preferred manner, the plane simultaneously intersects a maximum of one intermediate element across the entire longitudinal extension thereof. By the term “majority”, particularly more than 50%, preferably more than 80%, particularly preferably more than 95% is to be understood.

If the support element has a protective coating, which is provided for the purpose of protecting said support element from damage and/or corrosion, wear to the wiper blade device can be advantageously slowed down. With regard to a “protective coating”, particularly a coating is to be understood in this context, which is harder and/or more resistant to corrosion than the support element.

A wiper blade adapter can be mounted very quickly on the wind deflector element if the wiper strip unit has at least one fastening recess, which is provided for the purpose of forming a form closure with a wiper blade adapter.

If the wiper blade device comprises a wiper blade adapter, which has at least one fastening means, which forms a form closure with a wind deflector of the wiper strip unit and is provided for the purpose of preventing a movement of the wiper strip unit relative to the wiper blade adapter in a longitudinal direction, said wiper blade adapter can be very cost effectively and stably mounted to the wiper strip unit.

If the wiper blade adapter forms a form closure with the support element and prevents a movement of said support element relative to said wiper blade adapter in the longitudinal direction, the wiper device can be designed in a particularly compact manner.

If the wiper blade adapter is placed onto the wiper strip unit, wherein at least one fastening means engages in a form-fitting manner into the fastening recess, a quick and secure assembly can result.

If after fitting the wiper blade adapter to the wiper strip unit, a support element is inserted into the wiper strip unit and into a longitudinal guide unit, the wiper blade device can be embodied in a particularly stable manner. With regard to a “longitudinal guide unit”, particularly a unit is understood in this context, which is provided for the purpose of providing a guidance of a support element in the longitudinal direction. The longitudinal guide unit preferably comprises at least one guide groove extending in the longitudinal direction, which is provided for the purpose of forming a form closure with the support unit.

### BRIEF DESCRIPTION OF THE DRAWINGS

Further advantages ensue from the following description of the drawings. An exemplary embodiment of the inventions is depicted in the drawings. The drawings, the description and the claims contain numerous features in combination. The person skilled in the art will for reasons of expedience also consider the features individually and put said features together into further useful combinations.

In the drawings:

FIG. 1 shows a perspective view of a wiper blade device according to the invention in an assembled state,

FIG. 2 shows a perspective view of an end region of a wiper strip unit of the wiper blade device pursuant to FIG. 1,

FIG. 3 shows a perspective view of a further end region of the wiper strip unit pursuant to FIG. 2,

FIG. 4 shows a perspective view of the wiper blade adapter receiving region of the wiper strip unit pursuant to FIG. 2,

FIG. 5 shows a perspective view of a wind deflector of a wiper strip unit pursuant to FIG. 2,

FIG. 6 shows a perspective view of a support element of the wiper blade device pursuant to FIG. 1,

FIG. 7 shows a top view of a section of the support element pursuant to FIG. 6,

FIG. 8 shows a perspective view of a wiper blade adapter of a wiper blade device pursuant to FIG. 1,

FIG. 9 shows a perspective view of the wiper blade device pursuant to FIG. 1 in a first step of assembly,

FIG. 10 shows a perspective view of the wiper blade device pursuant to FIG. 1 in a second step of assembly,

FIG. 11 shows a perspective view of the wiper blade device pursuant to FIG. 1 in a third step of assembly.

### DETAILED DESCRIPTION

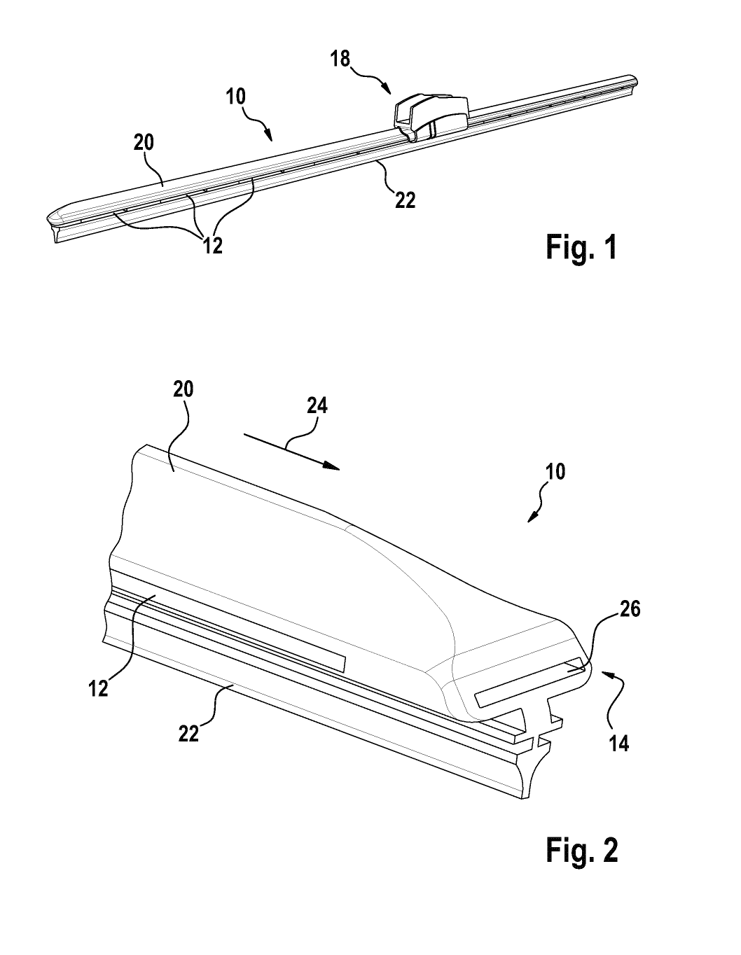

FIG. 1 shows a perspective view of an inventive wiper device comprising a wiper strip unit 10 and a wiper blade adapter 18 in an assembled state. The wiper strip unit 10 comprises a wind deflector 20 and a wiper lip 22. The wiper strip unit 10 includes a longitudinal guide channel 14, which has a plurality of lateral openings 12, which are distributed across the wiper strip unit 10 at regular intervals. The lateral openings 12 adjoin a plurality of intermediate elements 28 of the wiper strip unit 10. In addition, said lateral openings 12 adjoin the longitudinal guide channel 14 and laterally open the same. Said lateral openings 12 are delimited by a closed contour.

The intermediate elements 28 are in each case disposed between two lateral openings 12. Said intermediate elements 28 are furthermore integrally formed with the wind deflector 20. In this connection, it is however likewise conceivable to integrally form said intermediate elements 28 with the wiper lip 22.

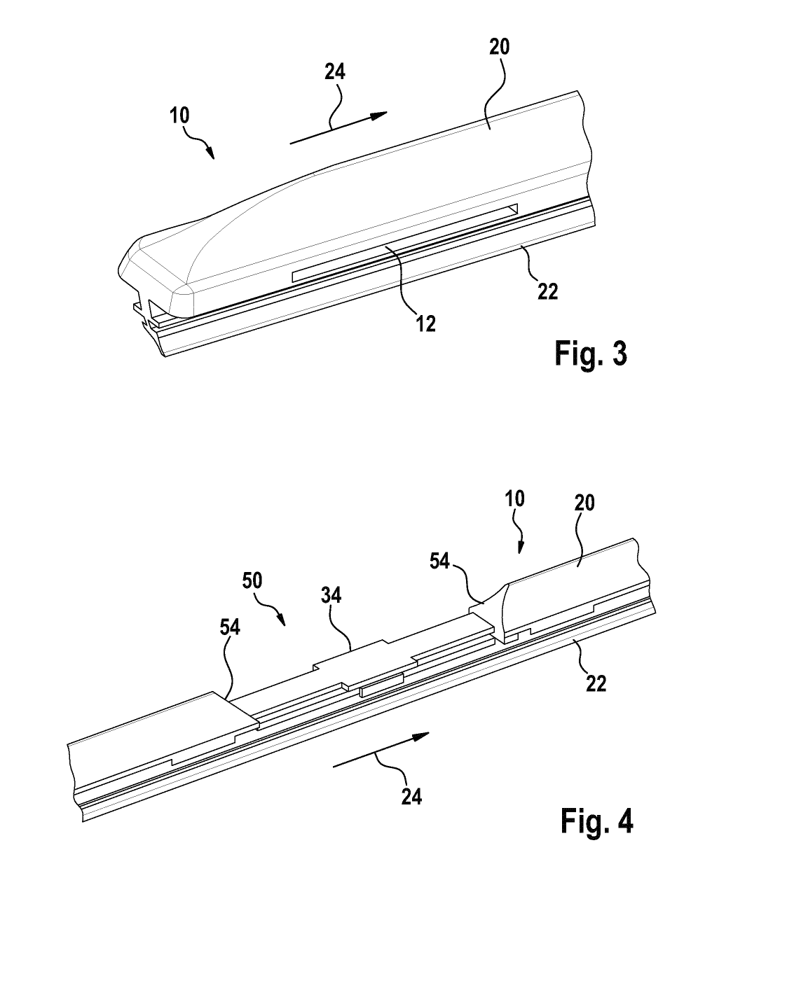

As shown in FIG. 2, the longitudinal guide channel 14 has a longitudinal guide channel opening 26, which opens said longitudinal guide channel 14 on one side in a longitudinal direction 24. The longitudinal direction 24 extends parallel to a longitudinal extension of the wiper strip unit 10. The lateral openings 12 extend transversely to the longitudinal direction 24. A main extension of the lateral opening 12 extends however parallel to the longitudinal direction 24. Said longitudinal guide channel 14 is closed (FIG. 3) in the longitudinal direction 24 on one side opposite the longitudinal guide channel opening 26.

FIG. 4 shows a wiper blade adapter receiving region 50 of the wiper strip unit 10 in a perspective view. A fastening recess 52 of the wiper strip unit 10 adjoins two lateral walls 54 of the wind deflector 20 and has a supporting surface 56. The lateral walls 54 enclose an angle of 45° with respect to the longitudinal direction. The supporting surface 56 is situated on a supporting body 58, which extends continuously in the fastening recess 14, i.e. adjoins the wind deflector 20 on both sides.

The longitudinal guide channel 26 of the wiper strip unit 12 is open at the lateral walls 54. The supporting body 58 continues the longitudinal guide channel 26 within the wiper blade adapter receiving region 50.

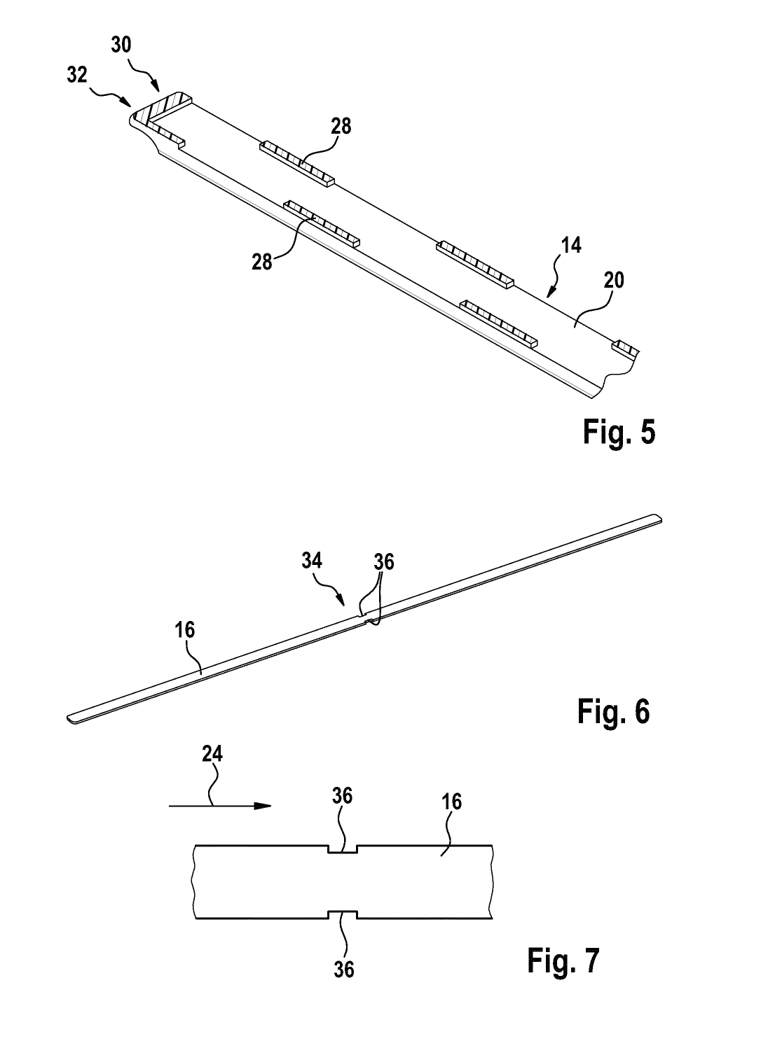

FIG. 5 shows a perspective view of a wiper deflector 20 without the wiper lip 22. The intermediate elements 28 are disposed in a first and a second longitudinal row 30, 32, which extend parallel to the longitudinal direction 24. The intermediate elements 28 of the first longitudinal row 30 are thereby disposed offset to the intermediate elements 28 of the second longitudinal row 32 when viewed in the longitudinal direction 24. During assembly, the wiper lip 22 is adhesively bonded to the wind deflector 20 and therefore joined by material engagement.

FIG. 6 shows a resilient support element 16 in a perspective view. The support element 16 consists of spring steel and comprises a centrally disposed detent means 34 which clasps two detent recesses 36. The support element 16 has a protective coating, which protects the same from damage and corrosion.

The detent recesses 36 are stamped from spring steel and have a rectangular profile, as can be seen in a top view in FIG. 7. In addition, the detent recesses 36 are disposed at the same height when viewed in the longitudinal direction 24. A cross-section of the support element 16 corresponds to cross-section of the longitudinal guide channel 14 which extends perpendicularly to the longitudinal direction 24.

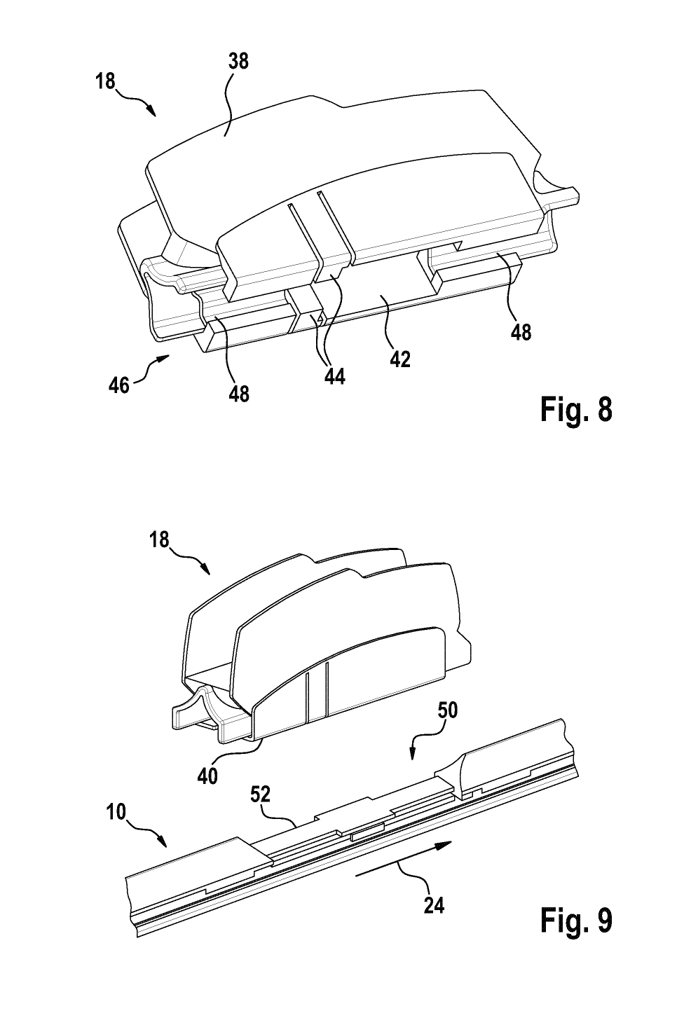

The wiper blade adapter 18 is shown in a perspective view in FIG. 8 and comprises a base body 38, on which two fastening means 40 are integrally formed. The fastening means 40 adjoin a central recess 42 of the base body 38. In addition, two detent hooks 44, which can deflect, are disposed on the base body 38.

In addition, the wiper blade adapter 10 has a longitudinal guide unit 46, which comprises four guide grooves 48. The guide grooves 48 extend parallel with respect to the longitudinal direction 24 and are open towards each other. Furthermore, said guide grooves 48 adjoin the central recess 42. A width of said guide grooves 48 corresponds to a thickness of the support element 16.

A first assembly step of the wiper blade device is depicted in FIG. 9. The wiper blade adapter 18 is disposed above the wiper blade adapter receiving region 50 of the wiper strip unit 10. If the wiper blade adapter 18 is placed onto the wiper strip unit 10, the fastening means 40 of said wiper blade adapter 18 engages in a form-fitting manner into the fastening recess 52 of said wiper strip unit 10. Said wiper blade adapter 18 forms a form closure with said wiper strip unit 10. A movement of said wiper strip unit 10 relative to said wiper blade adapter 18 is prevented in the longitudinal direction.

In a second assembly step, the support element 16 is inserted into the longitudinal guide channel 14 of the wiper strip unit 10. In the wiper blade adapter receiving region 50, said support element 16 departs from the longitudinal guide channel 14 into the supporting body 58 and is subsequently guided into the guide grooves 48 of the longitudinal guide unit 46 of the wiper blade adapter 18.

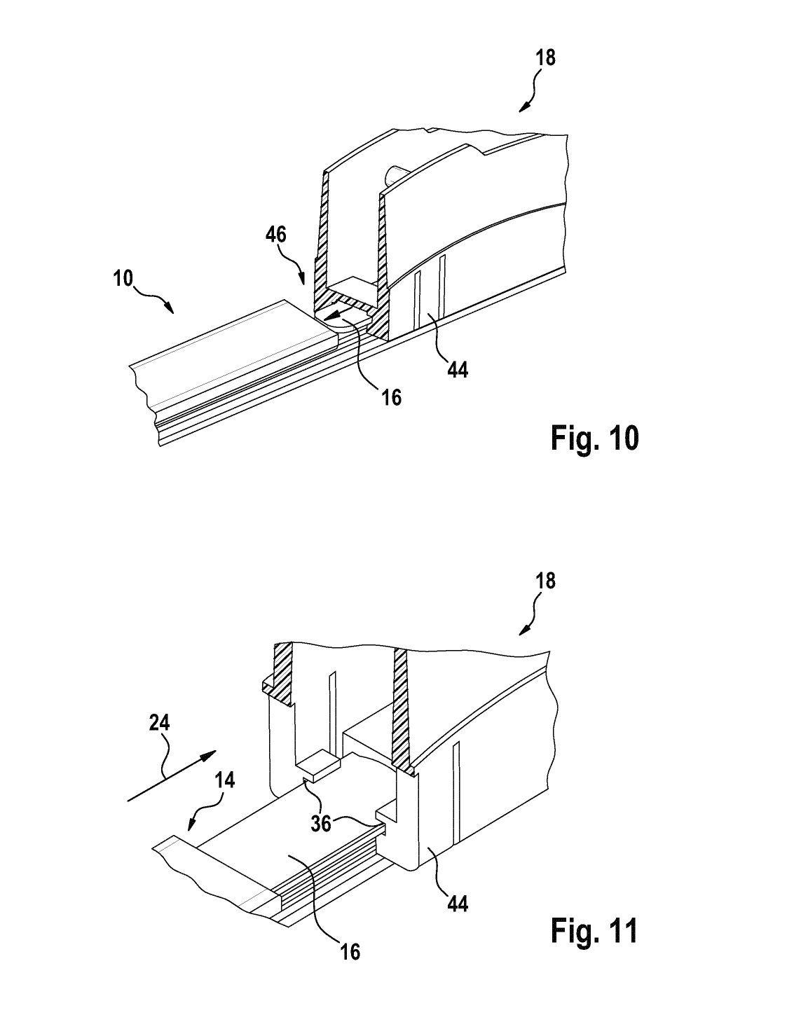

FIG. 10 shows the support element 16, which has been completely pushed through the longitudinal guide unit 46. Said support element 16 forms a form closure with the wiper blade adapter 18. The wiper blade adapter 18 can therefore no longer be released from the wiper strip unit 10, but is rigidly connected to the same.

The support element 16 is pushed further in a third assembly step until the detent hooks of the wiper blade adapter 18 engage into the detent recesses 36 of the support element 16 and form a snap-lock connection, as depicted in FIG. 11.

The detent hooks 44 are thereby initially deflected out of a starting position transversely with respect to the longitudinal direction 24 and move then resiliently back into the starting position. In so doing, a form closure is formed with the detent recesses 36 and a movement of the support element 46 relative to the wiper blade adapter 18 in the longitudinal direction 24 is prevented.

By pushing the support element 16 further along, said support element enters again into the longitudinal guide channel 14 of the wiper strip unit 10 and forms a form closure with the former. A movement of the support element 16 within the longitudinal guide channel 14 is prevented in any direction.

1. A wiper blade device comprising a wiper strip unit (10) which has a longitudinal guide channel (14) for accommodating a support element (16), characterized in that the longitudinal guide channel (14) has at least one lateral opening (12).

2. The wiper blade device according to claim 1, characterized in that the at least one lateral opening (26) adjoins intermediate elements (28) of the wiper strip unit (10).

3. The wiper blade device according to claim 2, characterized in that the intermediate elements (28) are integrally formed with a further component of the wiper strip unit (10).

4. The wiper blade device at least according to claim 2, characterized in that the intermediate elements are disposed in two longitudinal rows (30, 32).

5. The wiper blade device according to claim 4, characterized in that at least one intermediate element (28) of a longitudinal row (30) is disposed in a longitudinal direction (24) as viewed at the level of a lateral opening (12).

6. The wiper blade device according to claim 1, characterized in that the support element (16) has a protective coating protecting said support element from damage and/or corrosion.

7. The wiper blade device according to claim 1, characterized in that the wiper strip unit (10) has at least one fastening recess (52), for forming a form closure with a wiper blade adapter (18).

8. The wiper blade device according to claim 1, further comprising a wiper blade adapter (18) which has at least one fastening means (40) that forms a form closure with a wind deflector (20) of the wiper strip unit (10) and prevents a movement of said wiper strip unit (10) relative to said wiper blade adapter (18) in a longitudinal direction (24).

9. The wiper blade device according to claim 5, characterized in that the wiper blade adapter (18) forms a form closure with the support element (16), and a movement of said support element (16) relative to said wiper blade adapter (18) in the longitudinal direction (24) is prevented.

10. The wiper strip unit (10) of a wiper blade device according to claim 1.

11. The wiper blade adapter (18) of a wiper blade device according to claim 8.

12. A method for assembly of a wiper blade device according to claim 7, characterized in that the wiper blade adapter (18) is placed onto the wiper strip unit (10), wherein at least one fastening means (40) engages in a form-fitting manner into the fastening recess (52).

13. The method according to claim 12, characterized in that after placing the wiper blade adapter (18) onto the wiper strip unit (10), a support element (16) is inserted into said wiper strip unit (10) and into a longitudinal guide unit (46) of the wiper blade adapter (18).
